(19) United States
(12) Patent Application Publication
(10) Pub. No.: US 2003/0068162 A1
(43) Pub. Date: Apr. 10, 2003

(54) Updating system for digital players and method of using the same

(76) Inventors: Tzu-Li Tsai, Taipei Hsien (TW); Yen-Ching Chen, Taipei Hsien (TW); Szu-Hsiung Ko, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,842

(22) Filed: Feb. 21, 2002

(30) Foreign Application Priority Data
Oct. 4, 2001 (TW) 090124576

(51) Int. Cl. H04N 5/781

(52) U.S. Cl. 386/125; 386/126

(57) ABSTRACT

An updating system has a primary module and a secondary module. The primary module is an MEPG device with a random access memory, and the secondary module is a loader device with a flash memory. The primary module is connected to the secondary module via an IDE bus. The random access memory is used for operations of the primary module, which include updating the software stored in the flash memory. The software stored in the flash memory provides functionality for the secondary module, which includes reading data from a disk and transmitting it to the primary module. The primary module decodes and outputs the data as digital data. A disk with updating software can be placed into the secondary module. The secondary module loads updating software and transmits it to the primary module. The primary module then sends an updating instruction to the secondary module to update the software in the flash memory of the secondary module.

### BACKGROUND OF THE INVENTION

1. Field of the Invention

The present invention relates to an updating system and a method of using the same, and more particularly, to an updating system for a digital player and method of using the same.

2. Description of the Prior Art

Currently, most digital players have flash memory that stores predetermined software that is used to control the drive hardware of the digital player. During the research and development (R&D) process for the player, this software is frequently updated due to functionality enhancement and debugging. Typically, to update the flash memory, the flash memory is first desoldered from its circuit board within the digital player. Then, the software stored in the flash memory is updated by way of a recorder. The flash memory is then soldered back onto the circuit board of the digital player, completing the software updating process.

During the R&D process, updating the digital player by way of the method described above is a complicated and time-consuming task. Each update requires the soldering and desoldering of the flash memory from the circuit board.

Another updating method is used in the prior art to solve the above-noted problem. The digital player is installed with additional updating hardware. After a disk holding updating software is placed in the digital player, the updating software is loaded by the updating hardware and a predetermined program stored in the updating hardware writes the updating software into the flash memory.

With the method described above, each digital player needs additional specialized updating hardware. The predetermined program stored in the updating hardware must also be designed and developed. Although this method works without the soldering and desoldering process of the flash memory from the board, the additional updating hardware tends to increase manufacturing costs and makes the overall updating process more complicated. For example, the design of the predetermined program stored in the updating hardware is very complicated.

Please refer to FIG. 1 to FIG. 4, which are block diagrams of a prior art updating method that uses a personal computer to connect with a loader device to perform an updating process. As shown in FIG. 1, the personal computer sends at least one ATAPI instruction “1” 1001 to an updating program 1005 in the loader device. When the updating program 1005 receives the ATAPI command, a predetermined data size, for instance 128 Kbytes, of new software is to be transmitted to a buffer module in the loader device.

FIG. 2 illustrates an instruction format of the ATAPI instruction “1” 1001. The ATAPI instruction “1” 1001 includes an instruction 1101 (such as a predetermined command F1), a buffer address 1103, which indicates where the new software is to be transmitted, transmitted data size 1104, and a reserved space 1105. In addition, setting a field 1102 in the ATAPI instruction “1” 1001 to 1 indicates that the new software is to be transmitted to the buffer module in the loader device first.

As shown in FIG. 3, after performing the action described in FIG. 10, the personal computer sends an ATAPI instruction “2” 1201 to the updating program 1005 in the loader device. With this instruction, the new software in the buffer module in the loader device is examined and then the correct new software is moved to the flash memory of the loader device. With this done, the digital player is restarted to finish the updating process.

FIG. 4 illustrates the format of the ATAPI instruction “2” 1201. “FF” in position 1301 (in hexadecimal values) indicates the error examination for each byte. Position 1302 are error examination bytes. Setting position 1303 to “00” indicates restarting from address 00 after the new software is moved from the buffer module in the loader device to the flash memory in the loader device.

The method enumerated above, however, requires the use of a personal computer, the costs of which can be unnecessarily high. This makes the overall R&D process more expensive.

### SUMMARY OF THE INVENTION

It is therefore a primary objective of the present invention to provide an updating system for a digital player and a method of using the same which works without the processes of desoldering and soldering or additional hardware, and which simplifies the updating process of the flash memory.

There is another objective of the present invention to provide an updating system for a digital player and a method of using the same which integrates the updating process of an MPEG device and a loader device.

In a preferred embodiment, the present invention provides an updating system for a digital player comprising a primary module and a secondary module. The primary module is an MPEG device comprising a first memory module, for instance, a random access memory. The secondary module is a loader device comprising a second memory module, for instance, a flash memory.

The primary module is connected to the secondary module via a bus, for instance, an IDE bus. The first memory module is used to perform operations for the primary module. The operations include updating software stored in the second memory module, such as loading drivers. The software stored in the second memory module provides the secondary module with predetermined functionality, such as the loading of data to the first memory module in the primary module.

In addition, the secondary module can further include a disk holder to place a disk. The data carried in the disk is read and transmitted to the primary module. Then, the data is decoded by the primary module and then output as a digital form.

Furthermore, a disk carrying updating software can be placed into the secondary module. The data of the updating software is read and transmitted to the primary module. Then, the primary module sends an update instruction set to the secondary module for updating the software of the second memory module in the secondary module.

Moreover, the secondary module can be temporarily connected to a personal computer via an IDE bus, which is used to establish connection with the primary module. Therefore, the second memory in the secondary module can be updated directly by the personal computer.

The updating method for a digital player of the present invention utilizes the updating system described above. The updating system comprises a primary module and a secondary module. The primary module is a MPEG device comprising a first memory module, such as random access memory. The secondary module is a loader device comprising a second memory module, such as a flash memory. The secondary module is connected to the primary module via a bus, such as an IDE bus.

In the updating method of the present invention, a disk carrying software data is placed in the secondary module. The software data is read by the secondary module and transmitted to the primary module. The primary module sends an updating instruction set to the secondary module to upload the software data to the second memory module.

In the method described above, the secondary module further comprises a disk holder for accepting a disk. The secondary module reads the software data stored in the disk and transmits the software data to the primary module. Then, the primary module decodes the software data and outputs it as digital data. In addition, the secondary module can be connected to a personal computer so that the personal computer can upload software data to the second memory module.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 to FIG. 4 are block diagrams of an updating process for a digital player according to prior art.

FIG. 5 is a block diagram of an updating system for a digital player of the present invention.

FIG. 6 to FIG. 8 are block diagrams of an updating system for a digital player of a preferred embodiment according to the present invention.

FIG. 9 to FIG. 11 are block diagrams of an updating process for a digital player of a another preferred embodiment according to the present invention.

FIG. 12 and FIG. 13 are flow charts of an updating method for a digital player of the present invention.

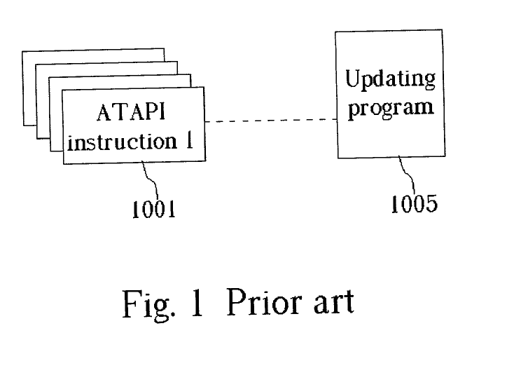

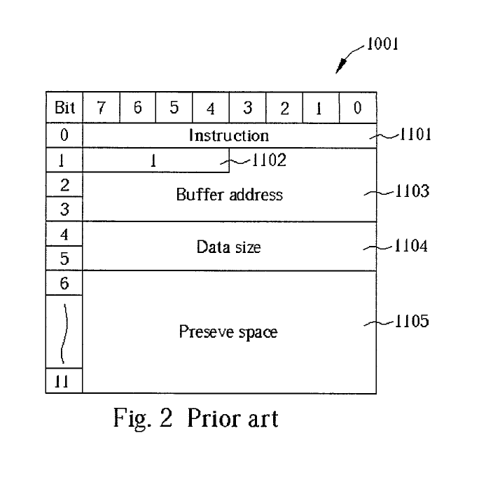

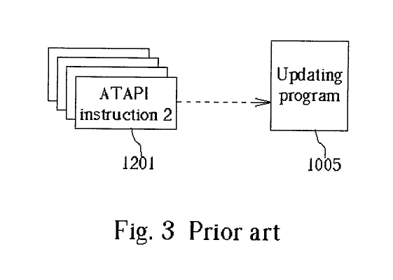

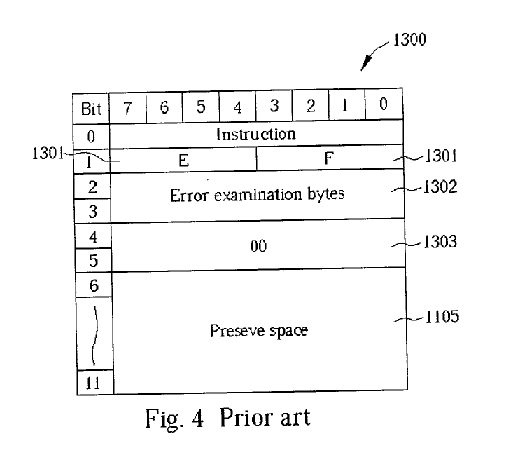

### DETAILED DESCRIPTION

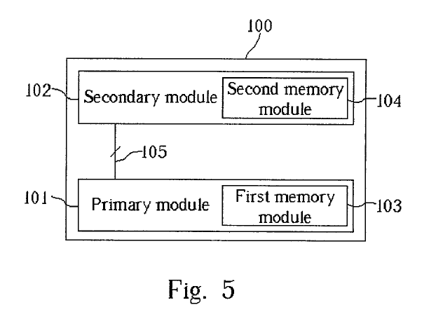

Please refer to FIG. 5, which is a block diagram of an updating system for a digital player 100 according to the present invention. The updating system for a digital player comprises a primary module 101 and a secondary module 102. The primary module 101 comprises a first memory module 103, operates actively, and uses the first memory module 103 for temporary storage. The secondary module 102 comprises a second memory module 104, operates passively, and requires the primary module 101 to perform operations. When the digital player 100 is initialized, a predetermined program is loaded as software for storage in the secondary module 104, and is temporarily stored in a predetermined position within the first memory module 103. Operations of the secondary module 102 are controlled by the primary module 101 and the software stored temporarily in the first memory module 103.

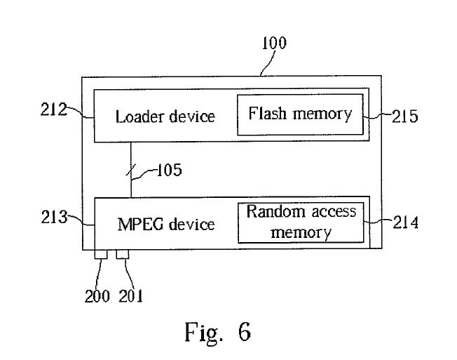

Please refer to FIG. 6 to FIG. 8, which are block diagrams of an updating system for a digital player of a preferred embodiment according to the present invention. As shown in FIG. 6, the primary module 101 is an MPEG device 213 comprising a first memory module 103 such as a random access memory 214. The secondary module 102 is a loader device 212 comprising a second memory module 104 such as a flash memory 215. The MPEG device 213 is connected to the loader device 212 via a bus 105 such as an IDE bus 105. The random access memory 214 enables the MPEG device 213 to perform operations that include updating software stored in the flash memory 215, such as loading a driver. The software stored in the flash memory 215 provides the loader device 212 with predetermined functionality, such as loading data into the random access memory 214 that is connected to MPEG device 213. In addition, the MPEG device 213 further comprises digital outputs, such as a sound data output 200 and a video data output 201.

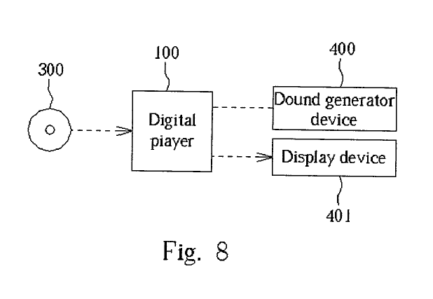

As shown in FIG. 8, the loader device 212 further comprises a disk holder 301 for accepting a disk 300. Data stored on the disk 300 is read and transmitted to the primary module 101 via the bus 105. The primary module 101 then decodes the data and outputs it at the sound data output 200 and the video data output 201. As shown in FIG. 8, the disk 300 is read by the digital player 100 for providing output to a sound generator device 400 and a display device 401.

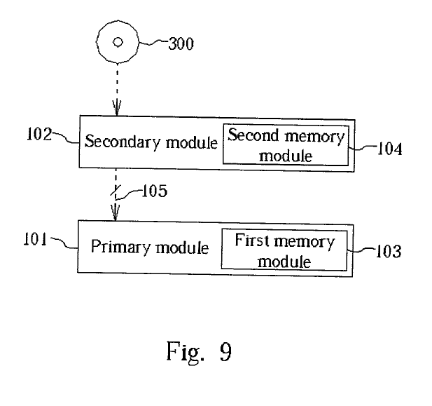

Please refer to FIG. 9 to FIG. 11, which are block diagrams of the updating process for a digital player of a preferred embodiment according to the present invention. As shown in FIG. 9, an updating process for the secondary module 104 is illustrated. After the disk 300, which carries updating software, is placed in the secondary module 102, the software data is read by the secondary module 102 and transmitted to the primary module 101. The primary module 101 sends an updating instruction to the secondary module 102 to upload the data in the first memory module 103 to the second memory module 104.

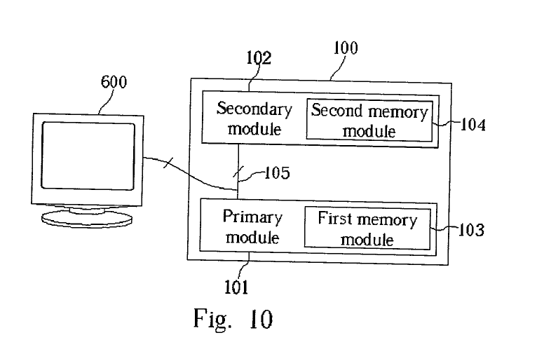

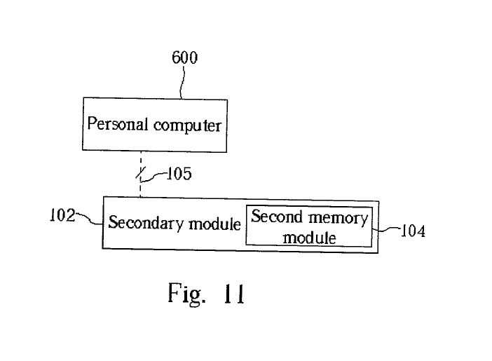

As shown in FIG. 10, the secondary module 102 can further be simultaneously connected to a personal computer 600 by way of the IDE bus 105, which connects to the primary module 101. The second memory module 104 in the secondary module 102 can be updated directly by the personal computer 600. As shown in FIG. 11, the personal computer updates the secondary memory module 104 in the secondary module via the IDE bus 105.

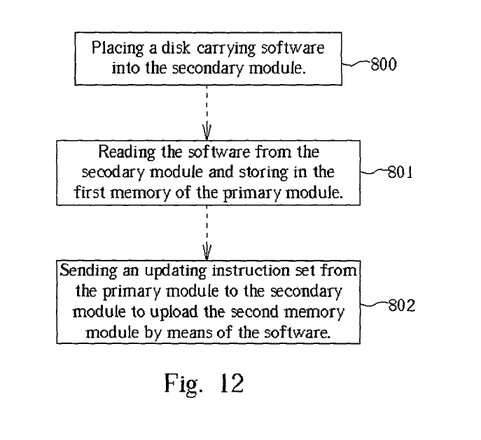

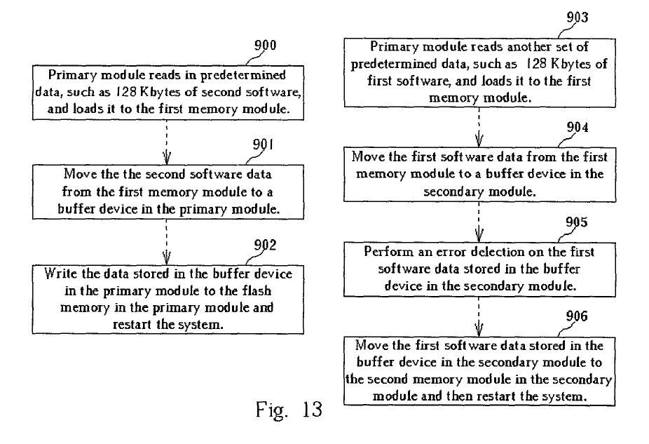

Please refer to FIG. 12 and FIG. 13, which are flow charts of an updating method for a digital player 100 of the present invention. The method utilizes the updating system described above. The updating system comprises the primary module 101 and the secondary module 102. The primary module 101 is an MPEG device 213 comprising the first memory module 103, such as a random access memory 214. The secondary module 102 is a loader device 102 comprising the second memory module 104, such as a flash memory 215. The secondary module 102 is connected to the primary module 101 via the bus 105, such as an IDE bus 105. The updating method of the present invention comprises the following steps: STEP 800: Placing the disk 300, which carries software data, into the secondary module 102; STEP 801: Reading the software data from the disk 300 and transmitting the software data to the primary module 101; and STEP 802: Sending an updating instruction to the secondary module 102 to upload the software data to the second memory module 104.

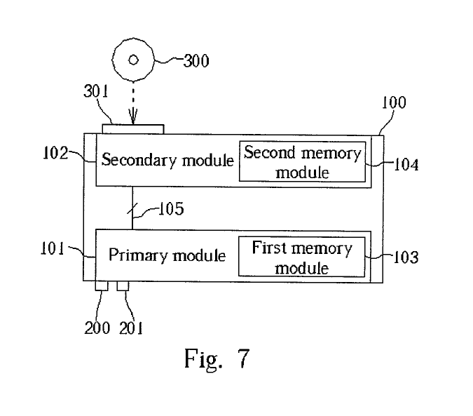

In the method described above, the primary module 102 further comprises a disk holder 301 for placement of the disk 300, as shown in FIG. 7. The secondary module 102 reads the data from the disk 300 and transmits this data to the primary module 101. Then, the primary module 101 decodes the data and outputs it as sound data via the sound output 200, and as video data via the video output 201. In addition, the secondary module 102 can further connect to a personal computer 600 via the IDE bus 105, as shown in FIG. 10. This enables the personal computer 600 to upload software data to the second memory module 104.

As shown in FIG. 13, the flash memory (not shown) in the primary module 101 and the second memory module 104 in the secondary module 102 can be updated by one disk 300 that holds two updating software modules. STEP 900 describes portions of the updating process of the primary module 101. STEPS 903 to 905 describe portions of the updating process of the secondary module 102. In STEP 900, the primary module 101 reads in predetermined data from the disk 300, such as 128 Kbytes from a second software module on the disk 300, and loads this data into the first memory module 103. In STEP 901, the second software module data is moved from the first memory module 103 to a buffer module (not shown) in the primary module 101. In STEP 902, the data stored in the buffer module in the primary module 101 is written to the flash memory (not shown) in the primary module 101, and then the system is restarted. In STEP 903, the primary module 101 reads another set of predetermined data from the disk 300, such as 128 Kbytes from a first software module, and loads this data into the first memory module 103. In STEP 904, the first software module data is moved from the first memory module 103 to a buffer module (not shown) in the secondary module 102. In STEP 905, error detection is performed to examine the first software module data stored in the buffer module in the secondary module 102. In STEP 906, the first software module data stored in the buffer module in the secondary module 102 is moved to the second memory module 104 in the secondary module 102, and then the system is restarted.

In contrast to the prior art, the updating system for a digital player and method using the same according to the present invention performs the updating process without the need for soldering and desoldering processes, or additional hardware. In addition, the present invention further simplifies the updating process of the flash memory and integrates the updating process of the MPEG device and the loader device.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An updating system for a digital player comprising:
a primary module comprising a first memory module for storing software; and
a secondary module comprising a second memory module and said primary module;
wherein an updating instruction is sent from said primary module to said secondary module to activate a predetermined program for updating said second memory module by means of said software stored in said first memory module.

2. The updating system of claim 1, wherein said digital player is a DVD player.

3. The updating system of claim 1, wherein said primary module is a MPEG device.

4. The updating system of claim 1, wherein said first memory module is a random access memory.

5. The updating system of claim 1, wherein said secondary module is a loader device.

6. The updating system of claim 1, wherein said second memory module is a flash memory.

7. The updating system of claim 1, wherein said primary module is connected with said secondary module via a bus.

8. The updating system of claim 7, wherein said bus is an IDE bus.

9. The updating system of claim 1, wherein said updating instruction set and said predetermined program are both in compliance with ATAPI protocol.

10. An updating method for a digital player, said digital player comprising a primary module comprising a first memory module, and a secondary module comprising a second memory module and said primary module, the method comprising:
placing a disk carrying software into said secondary module;
reading said software from said secondary module and storing said software in said first memory module of said primary module; and
sending an updating instruction from said primary module to said secondary module to activate a predetermined program for updating said second memory module by means of said software.

11. The updating method of claim 10, wherein said primary module is a MPEG device.

12. The updating method of claim 10, wherein said first memory module is a random access memory.

13. The updating method of claim 10, wherein said secondary module is a loader device.

14. The updating method of claim 10, wherein said second memory module is a flash memory.

15. The updating method m of claim 10, wherein said primary module is connected with said secondary module via a bus.

16. The updating method of claim 15, wherein said bus is an IDE bus.

17. The updating method of claim 10, wherein said digital player is a DVD player.

18. The updating method of claim 10, wherein said updating instruction set and said predetermined program are both in compliance with ATAPI protocol.

19. A digital player device capable of automatically updating data, said data updating being accomplished by means of a disk carrying a first software module and a second software module, said digital player device comprising:
a primary module comprising a primary memory module, a first buffer module, and a first flash memory module; and
a secondary module comprising a second buffer module and a second flash memory module;
wherein said secondary module loads sequentially said first software module and said second software module into said primary memory module, said primary module thereafter moves said first software module from said primary memory module to said first buffer module and consecutively programs said first flash memory module with said first software module; said primary module thereafter sends an updating instruction to said secondary module to activate a predetermined program for moving said second software module to said second buffer module, and after verifying said second software module, said second software module is written into said second flash memory module by means of said second buffer module.

20. The digital player device of claim 19, wherein said digital player device is a DVD player.

21. The digital player device of claim 19, wherein said primary module is a MPEG device.

22. The digital player device of claim 19, wherein said primary memory module is a random access memory.

23. The digital player device of claim 19, wherein said secondary module is a loader device.

24. The digital player device of claim 19, wherein said primary module is connected with said secondary module via a bus.

25. The digital player device of claim 24, wherein said bus is an IDE bus.

26. The digital player device of claim 19, wherein said updating instruction set and said predetermined program are both in compliance with ATAPI protocol.

27. An updating method for automatically updating a digital player, said digital player comprising a primary module having a primary memory module, a first buffer module, and a first flash memory module, and a secondary module having a second buffer module and a second flash memory module, said updating method is substantially accomplished by means of a first software module and a second software module carried by a disk, said updating method comprising:
loading sequentially said first software module and said second software module into said primary memory module by means of said secondary module;
moving said first software module from said primary memory module to said first buffer module by means of said primary module, thereafter writing said first software module into said first flash memory module; and
sending an updating instruction from said primary module to said secondary module to activate a predetermined program for moving said second software module to said second buffer module, and after verifying said second software, said second software module being written into said second flash memory module by means of said second buffer module.

28. The updating method of claim 27, wherein said digital player is a DVD player.

29. The updating method of claim 27, wherein said primary module is a MPEG device.

30. The updating method of claim 27, wherein said primary memory module is a random access memory.

31. The updating method of claim 27, wherein said secondary module is a loader device.

32. The updating method of claim 27, wherein said primary module is connected with said secondary module via a bus.

33. The updating method of claim 32, wherein said bus is an IDE bus.

34. The updating method of claim 27, wherein said updating instruction set and said predetermined program are both in compliance with ATAPI protocol.
